(19) United States
(12) Patent Application Publication
(10) Pub. No.: US 2008/0307232 A1
(43) Pub. Date: Dec. 11, 2008

(54) Method and a System for Authenticating and Recording Digital Documents and/or Files

(76) Inventor: Mauro Pasquinelli, Meda (IT)

Correspondence Address: Paul A. Fattibene;Fattibene and Fattibene, 2480 Post Road, Southport, CT, 06890, US

(21) Appl. No.: 11/658,417

(22) PCT Filed: Jul. 28, 2005
(86) PCT No.: PCT/EP05/08221

§ 371 Date: May 9, 2007

(30) Foreign Application Priority Data
Jul. 28, 2004 (IT) MI 2004 A 001533

(51) Int. Cl. G06F 21/00

(52) U.S. Cl. 713/178

(57) ABSTRACT

A method and a system are provided according to the present invention for authenticating and restoring digital files and/or documents, according to which, on the basis of each digital document to be authenticated, a bitmap file 3 is generated, a digital stamp 4 is added on a predefined area 3a of said bitmap file and a digital signature is added to the stamped bitmap file.

### FIELD OF THE PRESENT INVENTION

The present invention relates to the authentication of digital documents and/or files, wherein, in the frame of the present invention, the expression “authentication” has to be understood all those operations requested for giving a digital document a legal status so that said document may be used for any legal purpose according to the circumstances. Accordingly, the expression authentication has to be regarded as equivalent to similar expressions such as, for instance, certification, legalization, or the like. The present application further relates to the recording of authenticated digital documents and/or files. In particular, the present invention relates to a method and a system adapted for authenticating and recording digital documents and/or files. In more detail, the present invention relates to the authentication and recording of digital documents and/or files so that certified and authentic copies of said documents and/or files may be produced any time whenever the need arises without any risk that the authenticated documents originally stored have been manipulated, thus ensuring that the copies of the documents as produced later on entirely corresponds to the documents as originally stored or put into an electronic archive.

### DESCRIPTION OF THE PRIOR ART

Over the past years, a lot of development work has been devoted to the provision of methods and/or systems adapted to produce digital copies of documents originally printed on a paper support. This, in particular, is due to the fact that the storage of paper documents is usually very expensive, requires the provision of very big storing places and is mostly inefficient and expensive. In particular, in very big offices such as, for instance, public authorities, the need arises for avoiding as much as possible the production of paper documents or at least the need of providing digital copies of said paper documents, thus allowing paper documents to be destroyed as soon as digital copies of them have been produced. However, each time digital documents are produced and stored in the memory space of electronic and/or computer systems, the further problem arises of avoiding any unauthorized manipulation, amendment and/or modification of the digital documents and/or files as originally stored and/or recorded. For instance, it can be appreciated that if a digital copy of a legal file is produced (a business agreement, a payment receipt, a legal document or the like) it has to be ensured that the copy as stored may never be manipulated in an unauthorized manner. On the contrary, it has to be ensured and/or guaranteed that once the digital copy has been stored, each time said digital copy is retrieved, for instance, for the purpose of checking its content or producing further copies of it, the content of the digital file as retrieved entirely corresponds to that of the digital file as originally recorded. To this end, many efforts have been made in the past; however, the results obtained are not as it would be desired. In particular, as it will be explained in more detail in the following, the systems and/or methods known in the art for authenticating and recording digital documents and/or files are affected by several drawbacks, which render these systems and/or methods as not being absolutely reliable since said systems and/or methods essentially do not guarantee that the documents as stored or put into archives may not be made the subject of illegal uses and/or unauthorized manipulations. There is, in particular, no guarantee that each time a digital file and/or document is retrieved for any purpose, the content of the digital file and/or document as retrieved still corresponds to that of the digital document and/or file as originally stored.

Essentially, the solutions known in the art for avoiding illegal or fraudulent use of digital files or documents comprise:

protection of the access to the files;
digital signature of the files and addition of the time stamping;
memorization of the registration data relating to the files and the registration chronology in a DBMS (database management system);
certified post;
recording and storing the digital documents in remote servers.

However, as stated above and as it will become more clear with the following disclosure, none of the solutions listed above offers the requested guarantees that the recorded document or files may not be manipulated.

Concerning the prior art systems for protecting access to recorded files or documents, it has to be noted that once access to the files has been obtained, the files may be manipulated without leaving any trace that such a manipulation has been carried out. Users wishing to gain access to the files are made the subject of identification procedures so that only authorized persons may gain access to the recorded files or documents. However, the content of a file could even be manipulated and/or modified by a person authorized to have access to the file; in particular, if that is done, there is no means to detect this manipulation. Accordingly, one wishing to retrieve the document as originally recorded and/or stored could not realize and/or appreciate that he is actually not retrieving the original document but one that has been manipulated. Moreover, if copies of the document as retrieved are produced, these copies will not correspond to the document as originally stored. If, for instance, that is done in the case of a legal document stating that a transfer of money has been executed, the copies as retrieved could even state that the transfer has not been executed or state that a different amount of money has been transferred. The same considerations as stated above substantially apply in the case of the digital signature. In fact, if, on the one hand, a digital signature ensures that a particular document has been produced by the authority adding the signature, there is no guarantee concerning the uniqueness and/or real content of said document. This is, in particular, due to the fact that several documents, with corresponding different contents, could be produced and sent to corresponding different authorities for the purpose of obtaining different signed documents with corresponding different digital signatures. However, depending on the circumstances, some of these signed documents could be destroyed later on whilst the remaining document could be used for illegal purposes. For instance, different documents, each stating one of the possible results of a football match may be produced in advance (prior to the football match being played); once the football match is played and the final result becomes known, the two documents previously produced stating results not corresponding to the real result of the football match could be destroyed and only the document stating the correct result could be used for illegal purposes. In other words, if, on the one hand, the digital signature offers adequate guarantees concerning the origin of a document, no adequate guarantees are given concerning the real content of a document and the fact that a unique document was generated.

Essentially, the same drawbacks affecting the two solutions analyzed above also affect the prior art methods and systems of memorizing data in a DBMS. In fact, according to this solution (also known as document management), the digital documents are certified by means of the digital signature; moreover, all the operations executed with respect to a particular document are memorized and copies are produced of each transition concerning the said document. Furthermore, backup procedures are carried out and copies of the documents are stored in remote unities and the content of the digital files or document are encrypted in order to avoid said files being manipulated in an unauthorized manner. However, even if this solution offers certain guarantees concerning the security and reliability of the recording systems, less guarantees are offered concerning the real content of the documents as originally stored and/or recorded. For instance, the authority reputed to record a predefined document or file could be a competitor of the one who produced the original document. Accordingly, the recording authority, on receipt of the original document together with a request to encrypt this document and record it in an archive could modify the content of the document for illegal purposes and record a document not corresponding to the one as originally produced. In this case, there would be no possibility for the one who produced the original document to verify or realize that the original document has been manipulated.

In the case of certified post, it has to be noted that the essential feature of this technology relates to the fact that a copy of the communication is maintained by the provider so as to be able to demonstrate not only that the transition or transmission has been carried out but also that what has been received by the receiver exactly corresponds to what has been sent out by the provider. However, also in this case, the provider on receipt of an original document together with a request to transmit said document to a third person could manipulate and or modify said document before transmitting it to said third person. The receiver would, therefore, only be able to verify the conformity and/or correspondence between the copy transmitted and the copy as received but there would no possibility to check or verify whether this copy was modified or manipulated before it was sent out.

Concerning the recording of digital documents by remote, authorized providers, it has to be noted that once documents have been recorded by such a provider, normally there is no possibility of gaining access to the files as recorded and to manipulate them for illegal or fraudulent purposes. However, also in this case, the problem arises that there is no possibility to verify what has been indeed recorded in the remote provider. Also this solution is, therefore, affected essentially by the same drawbacks affecting the other solutions disclosed above.

Accordingly, in view of the problems explained above, it would be desirable to provide a technology that may solve or reduce these problems. In particular, it would be desirable to provide a method and a system for authenticating and recording documents adapted to overcome these problems. Furthermore, it would be desirable to provide a method and a system for authenticating and recording digital files and/or documents offering adequate guarantees that said documents may not be manipulated in an unauthorized manner for illegal purposes. Finally, it would be desirable to provide a method and a system for authenticating and recording digital files or documents, ensuring that each time the recorded documents are retrieved, they entirely correspond to those as originally stored.

### SUMMARY OF THE INVENTION

In general, the present invention is based on the consideration that the eventual manipulation of a digital file or document recorded in an archive may be detected if a document as originally recorded is provided with a digital stamp. In more detail, the present invention is based on the consideration that if, for each document to be authenticated and recorded, a digital stamp is produced and attached to the digital file or document, without any possibility of producing the same digital stamp for other or different documents, any attempt to manipulate these documents could be avoided or at least detected. Moreover, the present invention is based on the consideration that by adding a unique digital stamp to a digital file or document and by adding a digital signature to this document, any illegal use of this document may be avoided. In more detail, if a digital stamp and a digital signature are added to a digital file or document and if data relating to said digital stamp and said digital signature are sent to a remote server, an adequate level of reliability is obtained. In fact, by means of the digital signature, any attempt to manipulate the document would have, as a result, the modification of the hash number of the signature so that any manipulation of the document could be detected. Moreover, by adding a unique digital stamp to each document to be authenticated and recorded, it is ensured that no more copies of the document are produced.

On the basis of these considerations, the first embodiment of the present invention relates to a system for authenticating and recording digital documents or files as claimed in claim 1, namely a method comprising the steps of retrieving a digital document and/or file, generating a bitmap file of said digital document and/or file, generating a digital stamp, adding said digital stamp to said bitmap file so as to generate a stamped bitmap file, and adding to said stamped bitmap file a digital signature.

According to another embodiment of the present invention, a method for authenticating and recording digital files or documents as claimed in claim 2 is provided, namely a method comprising calculating the number of pages of said bitmap file, generating a sequential and/or progressive number, calculating the date and time at which the digital stamp is generated so that said digital stamp comprises data relating to said number of pages of said bitmap file, said sequential or progressive number, said date and time and a identification code.

According to still another embodiment of the present invention, a method is provided as claimed in claim 10, namely a method comprising the step of sending authentication data of each authenticated file or document to a central server and in that said authentication data comprises the hash number of said digital signature.

According to still another embodiment of the present invention, a method is provided as claimed in claim 12, namely a method comprising the step of encrypting the stamped and signed file or document.

According to another embodiment of the present invention, a system for authenticating and recording digital documents or files is provided as claimed in claim 18, namely a system for authenticating and recording digital files and/or documents according to a method as claimed in one of claims 1-17, said system comprising means for retrieving a digital file or document to be authenticated and recorded, means for generating a bitmap file of said digital file and/or document, said system being characterized in that it further comprises means for generating a digital, authentication stamp, means adapted to add said digital stamp to said bitmap file, and means adapted to generate a digital signature and to add said digital signature to said stamped bitmap file.

According to a further embodiment of the present invention, a system is provided as claimed in claim 19, namely a system comprising means for calculating the number of pages of said bitmap file, means for generating a sequential progressive number, means for calculating the date and time at which said digital stamp is generated, and in that said system is identified by an identification code, so that the digital stamp as generated comprises said identification code, said number of pages of the bitmap file, said progressive number and said date and time.

Further, additional embodiments of the present invention are defined in the appended claims.

### BRIEF DESCRIPTION OF THE DRAWINGS

Further advantages, objects and features as well as embodiments of the present invention are defined in the appended claims and will become more apparent with the following detailed description when taken with reference to the accompanying drawings, in which identical corresponding parts are identified using the same reference numbers.

FIG. 1 schematically depicts a view of a system for authenticating and recording documents according to the present invention;

FIG. 2 schematically depicts the sequence of the operation carried out according to the method of the present invention for authenticating and recording documents;

FIG. 3 depicts an example of a digital document to which a digital stamp has been added according to the present invention;

FIG. 4 represents in schematic view, an example of the data relating to the digital signature of a digital document;

FIG. 5 depicts the data provided to a user wishing to verify the content of a digital document or file authenticated and recorded according to the present invention;

FIG. 6 depicts an example of the mask a user is provided with for requesting/introducing identification data;

FIG. 7 depicts an example of the mask a user is provided with when trying to retrieve an authenticated document.

### DETAILED DESCRIPTION

While the present invention is described with reference to the embodiments as illustrated in the following detailed description as well as in the drawings, it should be understood that the following detailed description as well as the drawings are not intended to limit the present invention to the particular illustrative embodiments disclosed, but rather that the described illustrative embodiments merely exemplify the various aspects of the present invention, the scope of which is defined by the appended claims.

The present invention is understood to be of particular advantage when used to authenticating and recording documents originally produced and/or emitted as paper documents, i.e. documents on paper. For this reason, examples will be given in the following in which corresponding embodiments of the system and method according to the present invention are used for authenticating and recording documents originally produced and/or generated as paper documents. As it will become more apparent with the following disclosure, digital copies of said paper documents are generated which are then authenticated and recorded, for instance in an archive (remote or not) or a predefined database. However, it has to be noted that the method and system according to the present invention are not limited to the authentication and recording of documents originally produced as paper documents; on the contrary, the method and system according to the present invention may also be used for the purpose of authenticating and recording documents of any type. For instance, the method and system according to the present invention may be used for authenticating and recording images, sequences of images such as films, digital files and/or documents, or the like. The present invention is, therefore, also useful for the authentication and recording of all these documents, and the documents described in the following are to represent all these documents.

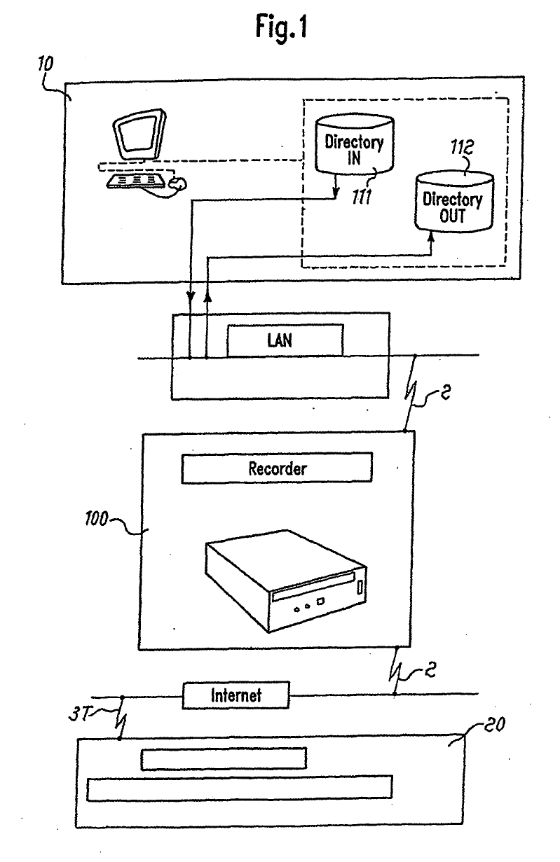

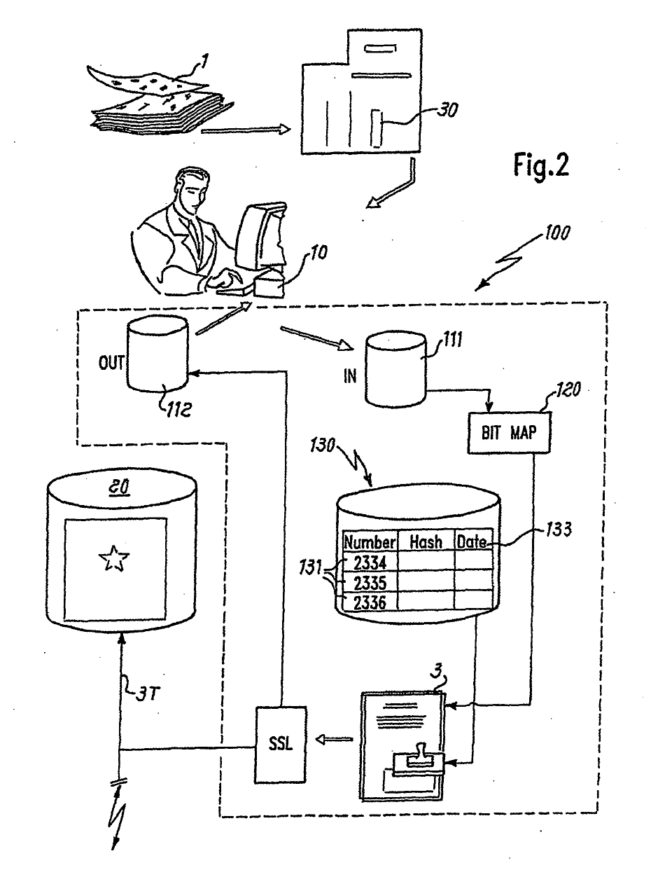

The first embodiment of the system according to the present invention will be described in the following with reference to FIGS. 1 and 2.

In FIG. 1, reference 100 identifies recording means (in the following also referred to as recorder for reasons of clarity) suitable for the authentication and recording of digital files and/or documents. The recorder 100 is adapted to be connected with a peripheral computing unity 10 (for instance a conventional personal computer) through a LAN net 2. Moreover, the recorder 100 is adapted to be connected through a connection 3T (for instance a telephone connection) to the WEB.

The hardware of the recorder 100 comprises in addition to features specified below, substantially standard equipments such as a CBU (for instance intelGH data), a RAM memory (for instance 1 gigabyte), a hard disk (8GE), reading/writing means (for instance a CD and a DVD), a port USB, a telephone connection (for instance LRJ IE488), an operating system (for instance Windows XP), a graphic program (for instance Office Viewers) and a device for managing a database (DBSM database management system, for instance Microsoft MSDE). For the purpose of rendering the recorder 100 inaccessible to authorized persons the recorder 100 may be protected by means of adequate seals, for instance a metal spring or thread connecting two covering portions of the recorder, with two end portions of said string or thread being connected by a bleed seal. Moreover, the screws connecting the two portions of cover of the recorder may be blocked or sealed as well.

The recorder 100 is connected with the computing unity 10 through two directories, namely an input directory 111 and an output directory 112. In the embodiment depicted in FIG. 1, the input and output directories 111 and 112 are depicted as belonging to the unity 10; however, according to the circumstances, other embodiments are possible in which the input and output directories 111 and 112 are incorporated in the recorder 100 and belong, therefore, to said recorder 100. The purpose of the input directory 111 is that of allowing a user working on the unity 10 to load digital files and/or documents so that these documents may be retrieved by the recorder 100. The purpose of the output directory 112 is that of allowing a digital file or document, adequately certified by the recorder 100, to be retrieved by a user working on the unity 10. Of course, several computing unities may be connected with the recorder 100 through the input and output directories 111 and 112 so that corresponding users may interact online and simultaneously with the recorder 100.

The recorder 100 is identified by a unique own identification code. As it will be explained in more detail in the following, said unique identification code is used according to the present invention, for generating a digital stamp which is then added during the authentication procedure to a digital file or document previously loaded in the input directory 111 and retrieved by the recorder 100. In this way, all the digital files or documents authenticated by the recorder 100 will be identified by the identification code of the recorder, thus enabling said digital files or documents to be distinguished from digital files or codes authenticated by other reorders or even by other authentication systems.

The connection to the internet allows data relating to a particular authenticating procedure (carried out for authenticating a particular digital file or document) to be stored in the remote server 20. Said data relating to said authentication procedure are also loaded and stored in the output directory 112 together with the digital file or document authenticated according to said authentication procedure. In this way, a user wishing to retrieve an authenticated document from the output directory 112 will be able to compare the authentication data stored in the output directory 112 with the authentication data stored in the remote server 20; accordingly, in the case that the digital file or document stored in the output directory 112 has been manipulated or modified (for instance by an unauthorized person) the user will immediately realize that such a manipulation has taken place by simply comparing the authentication data stored in the output directory 112 with the authentication data stored in the remote server 20.

The recorder 100 is equipped with a software program adapted to analyze the local LAN net 2 as well as the local server, with all the IP addresses of all the computing unities connected with the recorder, so that the recorder 100 is adapted to configure itself as a node of the net without any manual intervention or operation. Accordingly, as soon as the recorder 100 is switched on, said recorder 100 is adapted to interact with all the computing unities connected to the recorder, thus allowing the users working on said computing unities to interact with the recorder 100 and to use the functions of said recorder.

In the following, the components parts of the recorder 100 (or, in other words, the subsystems of said recorder 100) will be described with reference to FIG. 2 together with the functions exploited by said component parts. In FIG. 2, those parts already described with reference to FIG. 1 are identified with the same reference numerals.

As stated above, the recorder 100 is connected to a computing unity 10 through the input directory 111 and the output directory 112; in particular, in the embodiment depicted in FIG. 2, said input and output directories 111, 112 are represented as belonging to the recorder 100. The input directory 111 allows a user to temporarily load or memorize a digital file or document to be authenticated; in this way, said digital file or document is put at the disposal of the recorder 100 which will then recognize said document. Moreover, the recorder 100 will retrieve the digital file or document from the input directory 111 (either automatically or following an input of the user) and transfer same to the next subsystem 120 of the recorder. The output directory 112 is provided for the purpose of allowing the digital file or document which has been the subject of the authentication procedure to be loaded in the output directory 112 so as to be at the disposal of one or more of the users connected with the recorder 100. In particular, the digital file or document loaded in the output directory 112 will be identified by an authentication code and a termination “P7M” identifying all the digital files or documents provided with a digital signature.

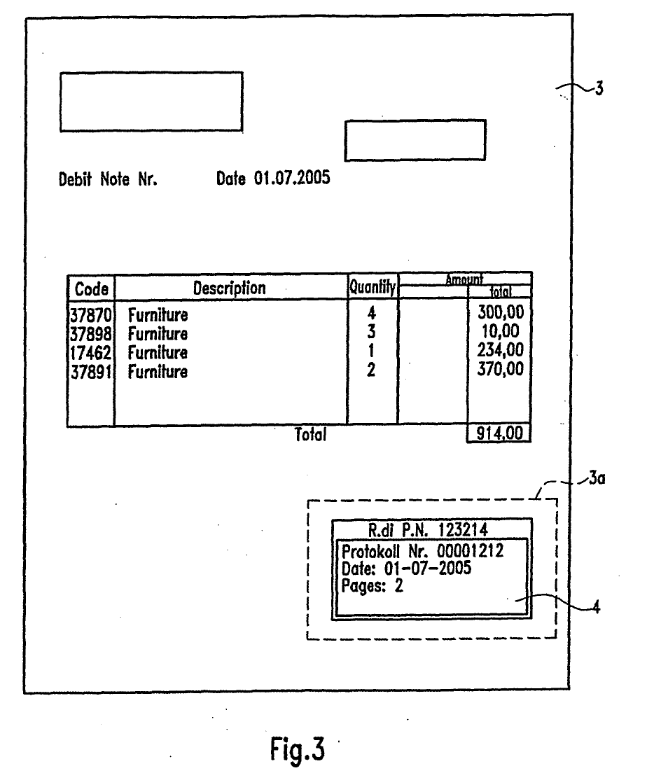

In FIG. 2, reference numeral 120 identifies a further subsystem of the recorder 100 adapted to exploit the functions of retrieving the digital file or document previously loaded into the input directory 111 and to generate a bitmap file 3 (see also FIG. 3) of said digital file or document. In particular, the expression bitmap file is to be understood, in the light of the present invention, as meaning a graphic file with the same content as the original digital file or document. Moreover, the format of the original file or document is maintained in the bitmap file. The purpose of said bitmap file is that of providing a document on which a digital stamp (generated as explained below) may be added on a predefined area opportunely selected to this end. Once the bitmap file 3 depicted in FIG. 3 has been generated, said bitmap file 3 is sent or transferred to the next subsystem 130 to be described below.

The subsystem 130 depicted in FIG. 2 represents the core of the system according to the present invention for authenticating and recording digital documents. In fact, the subsystem 130 is adapted to exploit some of the most important functions of the system and method according to the present invention. Said functions comprise in particular;

generating a sequential and/or progressive number 131 also referred to as the “number of protocol”; this number of protocol will be used for generating a digital stamp to be added to the bitmap file 3. The subsystem 130 further comprises means for incrementing said number of protocol of one unity each time an authentication procedure has been exploited and a digital document has been authenticated and recorded. In this way, each new digital stamp will differ from the last stamp generated by the subsystem 130 so that each new digital document will be assigned a different number of protocol and, therefore, a different digital stamp;
means for generating a digital stamp 4 to be added to the bitmap file;
means for calculating the date and time (hour, minutes and seconds) at which the authenticating operations are carried out; and
means for automatically calculating the number of pages of the bitmap file 3.

With respect to the generation of a digital stamp, it has to be noted that this digital stamp will comprise the identification code of the recorder 100, the sequential number 131 (number of protocol) as generated, the date and time as calculated and the number of pages of the bitmap file. It has also to be noted that the digital stamp is generated as a “raster” image adapted to represent the digital stamp 4, which, in turn, is adapted to be superimposed or added to the front page (the first page) of the bitmap file.

It results, therefore, from the above that each digital stamp as generated by the subsystem 130 of the recorder 100 according to the present invention, will differ from all other digital stamps generated by the same recorder since each single stamp will have at least its own number of protocol and its own date and time differing from those of all other digital stamps. Moreover, all digital stamps generated by a predefined recorder will differ from those generated by other recorders since at least the identification codes of the recorders contained in the digital stamp will differ.

For the purpose of adding or superimposing a digital stamp to the bitmap file 3, the system according to the present invention comprises means suitable for identifying an adequate area of the front page of the bitmap file 3. For instance, as depicted in FIG. 3, this area may be an empty area or an area containing at least as little information or data as possible. According to a preferred embodiment of the present invention, the system is adapted to analyze the pixel matrix of the bitmap file, distinguishing the black pixels from the white pixels, thus identifying the area containing the lowest number of black pixels. In particular, the system disregards all those areas comprising more than 5% of black pixels and takes into consideration all the areas containing less than 5% of black pixels. Along these areas with less than 5% of black pixels, the area is selected with the lowest number of black pixels. Once at least one area has been identified suitable for receiving the digital stamp 4 as previously generated, said digital stamp is superimposed or added to the bitmap file in the area of the front page of the bitmap file as previously identified. In FIG. 3, there is depicted the bitmap file as generated according to the present invention on the basis of an original digital file or document. In particular, the bitmap file of FIG. 3 relates to a debit note which has to be authenticated and recorded. The white area 3a of FIG. 3 is the area on which the digital stamp 4 has been added. The “stamped” bitmap file 3 will, therefore, differ from the bitmap file generated by the system in that the first page of the stamped bitmap file will contain the digital stamp in a predefined area of said first page.

Once the digital stamp 4 has been added to the bitmap file 3, a digital signature is added to the “stamped” bitmap file. Adding a digital signature is automatically carried out by a software program adapted to this end of the kind delivered by the known certification authorities. Said software program is memorized in the hard disk of the system and is adapted to include the stamped bitmap file in a virtual envelope containing both the bitmap file and data relating to the certification or signature procedures. According to the most modern techniques, the procedure for adding the digital signature comprises the generation of a “integrity code” also referred to as a hash number, with this hash number comprising both numbers and letters. An example of the certification (authentication) data as generated is depicted in FIG. 5, wherein in the right hand side of the figure (last line) an example of the hash number is given.

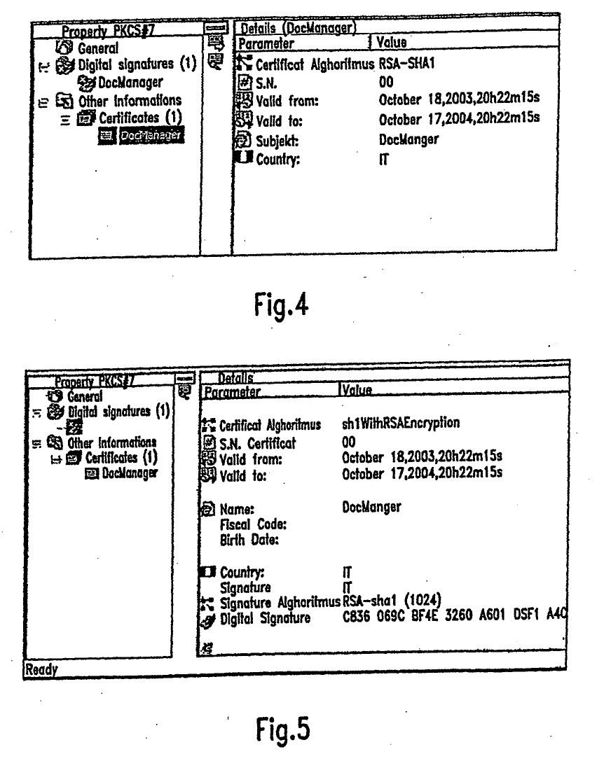

The authentication data (for instance the authentication data as depicted in FIG. 4) may be memorized or stored in a remote server. Moreover, said authentication data may be saved or stored, together with the bitmap file containing the digital stamp and the digital signature in a different place, for instance in the output directory 112. In this way, each time the need will arise to retrieve the stamped and signed bitmap file from the directory 112, each user wishing to retrieve this document will be provided with information of the kind depicted in FIG. 5. It will, therefore, be possible for this user to compare, either manually or automatically by means of a particular program adapted to this end, the authentication data enclosed in the bitmap file and stored in the output directory 112 with those stored in the remote server. Any difference between these two sets of authentication data (in particular, between the two hash numbers) will therefore indicate that the bitmap file as retrieved has been manipulated and, therefore, does not correspond to the bitmap file as stamped, signed and originally stored in the output directory 112. On the contrary, in the case that the registration data (in particular the two hash numbers) will correspond, a user retrieving a bitmap file will have the guarantee that the bitmap file as retrieved entirely corresponds to the bitmap file as stamped, signed and originally stored in the output directory 112. Accordingly, in this case, it will be, for instance, possible to produce copies of the bitmap file as retrieved and use said copies for any purpose, even for any legal purpose.

According to a preferred embodiment of the method and system according to the present invention, it is also possible to encrypt the bitmap file comprising the digital stamp and the digital signature either before or after transferring said bitmap file to the output directory 112. In the embodiment depicted in FIG. 2, encryption of the bitmap file is carried out before sending same to the output directory 112 and before sending the registration data to the remote server 20. The encryption procedures and/or operations are based on international standard algorithms known as “SSL” (secure socket layers) and representing the security standard in the transitions through the internet. The purpose of the encryption procedures is that of preventing unauthorized persons gaining access to the bitmap files and/or to use same; in this way, the privacy and secrecy of the bitmap files are ensured. Moreover, encrypting the bitmap files offers the advantage that unauthorized persons may not gain access to the bitmap files even in the case that the said bitmap files are stolen or illegally obtained by said unauthorized persons. Only the persons owning the passwords requested for opening the encrypted files may visit the corresponding databases and use the encrypted files stored therein; in particular, only the persons owning the requested passwords may print, display and/or send the encrypted files. The identity of the persons and/or users trying to gain access to the encrypted files and/or documents is verified by the system; in particular, two different numbers, both inserted by the user, are verified, wherein the first of said two numbers is adapted to authorize the user to insert a second number. These techniques do not allow several attempts to be carried out for the purpose of gaining access to the encrypted files or documents, since only with the insertion of the correct first number is the user allowed to insert the second number. Moreover, since the system is also adapted to register any access to the encrypted files or even any attempt to gain access to the encrypted files, any person trying to gain access to the encrypted files may be identified.

According to a still preferred embodiment, the system according to the present invention comprises means for storing and/or memorizing a copy of the bitmap comprising the digital stamp and the digital signature on a removable optical support, adapted to be stored in a protected container. This will allow, in the case of breakdown or damage of the system (in particular of the recorder 100) as well as in the case of theft or stealing of the recorder, to put said optical support in a new recorder, thus restoring and/or reinstating the original situation. This technique of copying the bitmap files on a removable support is also in conformity with the most common legal dispositions for storing digital documents. Moreover, if the bitmap file is stored on such a removable support, the original documents on the basis of which the bitmap file has been generated, for instance the paper document, may be destroyed.

According to a still preferred embodiment, the system according to the present invention comprises means for identifying the persons and/or users interacting with the system. In particular, FIG. 6 depicts an example of an access mask the user is presented with, when said user tries to retrieve the stored bitmap files or even to interact with the system. As apparent from FIG. 6, the user is provided with an identification number and a personal password. Each time said user tries to gain access to the system, for instance for the purpose of retrieving bitmap files comprising digital stamp and digital signature stored in the system, the user will be requested to introduce his personal password. In this way, any operation executed by the user will be registered and memorized. It will, therefore, be possible to verify any abuse or illegal operations; moreover, the identity of the person responsible for said illegal operation can be verified.

In the following, with reference to FIG. 2, further features of the system and method according to the present invention will be described.

As depicted in FIG. 2, the system is connected to both the output directory 112 and one or more remote servers 20. As stated above, each digital file comprising the digital stamp and the digital signature is forwarded and/or transmitted to the output directory 112 together with the data relating to the registration and/or authenticating procedure concerning the file. Moreover, said registration data comprising in particular the hash number are separately sent to one or more remote servers 20. For instance, the transmission to the directory 112 and to one of the remote servers 20 may be an SSL encrypted transmission. Moreover, the registration data sent to one of the remote servers 20 and enclosed to the bitmap file sent to the output directory 112 comprise the identification number of the recorder 100 the number of the protocol of file or document transmitted, the date and time (hour, minutes and seconds) at which the authentication of the file was executed and the number of pages of the bitmap file as transmitted, along with the hash number of the digital signature. In this way, it will be possible to verify whether a bitmap file as retrieved from the output directory has been manipulated or not. In fact, a manipulation of this file will result in the registration data, in particular the hash number of the digital signature being modified and thus no longer corresponding to the registration data (in particular the hash number of the digital signature) stored in the server 20.

In the following, with reference to FIG. 2, the method for authenticating and restoring documents as disclosed above will be summarized.

At the beginning of the operations, a digital document or file is loaded into the input directory 111; for instance, said digital file may have been obtained by scanning, by means of a scanner 30, a paper document 1, otherwise the digital file or document may have been directly generated by the computing unity 10, for instance following the input of a user working on said computer unity 10. Once the digital document or file has been loaded into the input directory 111, the real authenticating operation begins in that the digital file or document is retrieved from the input directory 111, either automatically or following an input of a user interacting with the system 100 and a bitmap file is generated by the subsystem 120. Also the generation of the bitmap file 120 may be executed either automatically or following an input of the user. The bitmap file as generated is then sent and/or transmitted to the authentication and/or stamping subsystem 130. In particular, the subsystem 130 identifies an appropriate area in the front page of the bitmap file adapted to receive a digital stamp. Moreover, the subsystem 130 generates a digital stamp comprising the identification code of the recorder 100, the progressive number of protocol assigned to the document to be authenticated, the date and time at which the authentication operation is executed and the number of pages of the document. The system automatically generates the number of protocol simply by incrementing the number of protocol relating to the last authenticated document of one unity. The digital stamp as described above is then added to the bitmap file, in particular, in an area identified by the system. Subsequently, the bitmap file comprising the digital stamp is provided with a digital signature. Providing the bitmap file with the digital signature means generating a set of data relating to the signature procedure with said data comprising in particular the hash number of the digital signature (examples of said “registration” data are given in FIGS. 4 and 5); the bitmap file comprising a digital stamp and the digital signature is then transmitted (either before or after having been encrypted) to the output directory 112, along with the registration data relating to the signature. Moreover, the data relating to the digital signature (comprising in particular the hash number, see FIGS. 4 and 5) are sent to one or more remote servers 20 so that each user trying to retrieve a particular bitmap file comprising the digital stamp and the digital signature will be able to compare the hash number of the digital file as retrieved with the hash number as stored in the remote server, thus immediately realizing whether the bitmap file as retrieved has been modified and/or manipulated or in other words, whether the bitmap file as retrieved entirely corresponds to the bitmap file as originally produced and/or generated.

It arises, therefore, from the above disclosure that the system and method according to the present invention for authenticating and restoring digital files or documents allow to overcome or at least to minimize the drawbacks effecting the methods and the systems known in the art; in particular, the system and method according to the present invention allow reliable authentication of digital files or documents without any risk that said digital authenticated files or documents being manipulated by unauthorized persons. In particular, the use of the digital stamp in combination with the digital signature allows the avoidance of risking that different copies of the same original documents are produced and that one or more of these copies may be used later on for illegal purposes.

While the present invention has been described with reference to particular embodiments, it has to be understood that the present invention is not limited to the particular embodiments described but rather that various amendments may be introduced into the embodiments described without departing from the scope of the present invention which is defined by the appended claims.

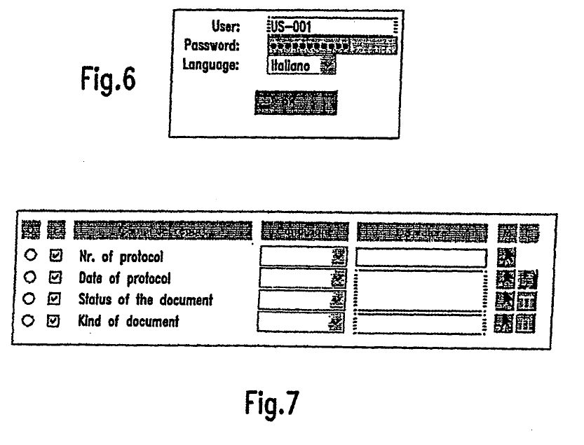

For instance, additional features and functions may be added to the system described above; in particular searching means may be introduced for the purpose of allowing users to search and retrieve documents. According to a particular embodiment, the users (for instance those working on the computing unities 10), are provided or presented to with a search mask as depicted in FIG. 7. As apparent from FIG. 7, a user wishing to retrieve a document will be able to insert data concerning the document, such as the number of protocol, the date of the protocol, the status of the document and the kind of document. The system will therefore automatically search for the document, identify the database where the document was restored, identify the document and put it at the disposal of the user.

1. A method for authenticating and recording digital documents and/or files by means of a system (100) adapted to this end, said method comprising the steps of:
retrieving a digital document and/or file;
generating a bitmap file (3) of said digital document and/or file;
said method being
characterized in that
it further comprises the steps of:
generating a digital stamp (4);
adding said digital stamp (4) to said bitmap file (3) so as to generate a stamped bitmap file; and
adding to said stamped bitmap file a digital signature.

2. A method as claimed in claim 1,
characterized in that
said step of generating said digital stamp (4) comprises calculating the number of pages of said bitmap file (3), generating a sequential and/or progressive number, calculating the date and time at which the digital stamp is generated and in that said digital stamp comprises data relating to said number of pages of said bitmap file, said sequential or progressive number, said date and time and a identification code of said system (100).

3. A method as claimed in claim 2,
characterized in that
said sequential and/or progressive number is incremented by one unit each time a new digital stamp is generated.

4. A method as claimed in one of claims 1-3,
characterized in that
it further comprises the step of identifying an area in said bitmap file on which said digital stamp may be added.

5. A method as claimed in claim 4,
characterized in that
said area is identified as an area substantially free from information of the first page of said bitmap file.

6. A method as claimed in one of claims 1-5,
characterized in that
said digital signature is of the kind P7M.

7. A method as claimed in one of claims 1-6,
characterized in that
said system (100) comprises an input directory (111) and an output directory (112) and in that said method further comprises saving and/or storing said stamp and signed bitmap file or document in said output directory.

8. A method as claimed in claim 7,
characterized in that
said method further comprises the step of periodically analyzing the content of said input directory and in that the digital file or documents in said input directory are automatically retrieved.

9. A method as claimed in claim 8,
characterized in that
said step of periodically analyzing the content of the input directory is automatically executed by said system (100).

10. A method as claimed in one of claims 1-9,
characterized in that
said method further comprises the step of sending authentication data of each authenticated file or document to a remote server and in that said authentication data comprises the hash number of said digital signature.

11. A method as claimed in claim 10,
characterized in that
said step of sending the authentication data to a remote server is executed according to a SSL procedure.

12. A method as claimed in one of claims 1-11,
characterized in that
said method further comprises the step of encrypting the stamped and signed file or document.

13. A method as claimed in claim 12,
characterized in that
said encryption step is executed by means of an SSL procedure.

14. A method as claimed in one of claims 1-13,
characterized in that
said method further comprises the step of allowing an external user to obtain access to the output directory by using a security code.

15. A method as claimed in claim 14,
characterized in that
said security code comprises a first and a second number, the first of which is adapted to allow insertion of the second.

16. A method as claimed in one of claims 1-15,
characterized in that
said method further comprises the step of checking the identity of users wishing to gain access to the system (100).

17. A method as claimed in claim 16,
characterized in that
said step of checking the identity of said users is based on an identification number and an access password inserted by the user.

18. A system (100) for authenticating and recording digital files and/or documents according to a method as claimed in one of claims 1-17, said system comprising:
means for retrieving a digital file or document to be authenticated and recorded;
means for generating a bitmap file (3) of said digital file and/or document;
said system being
characterized in that
it further comprises:
means for generating a digital, authentication stamp (4);
means adapted to add said digital stamp (4) to said bitmap file (3); and
means adapted to generate a digital signature and to add said digital signature to said stamped bitmap file.

19. A system as claimed in claim 18,
characterized in that
it further comprises means for calculating the number of pages of said bitmap file (3), means for generating a sequential progressive number, means for calculating the date and time at which said digital stamp (4) is generated, and in that said system is identified by an identification code, so that the digital stamp as generated comprises said identification code, said number of pages of the bitmap file, said progressive number and said date and time.

20. A system as claimed in claim 19,
characterized in that
said means for generating said sequential and/or progressive number comprise means adapted to increment said number each time a new digital stamp is generated.

21. A system as claimed in one of claims 18-10,
characterized in that
the system further comprises means for identifying an area of said bitmap file on which said digital stamp may be added.

22. A system as claimed in claim 21,
characterized in that
said means for identifying said area are adapted to identify a substantially free area on the first page of said bitmap file.

23. A system as claimed in one of claims 18-22,
characterized in that
said means for generating said digital signature are adapted to generate a signature of the kind MIME P7M.

24. A system as claimed in one of claims 18-23,
characterized in that
said system further comprises an input directory (111) and an output directory (112) and in that said system further comprises means for storing and/or saving said stamped, signed bitmap file in said output directory.

25. A system as claimed in claim 24,
characterized in that
said system further comprises means for periodically checking the content of said input directory.

26. A system as claimed in claim 25,
characterized in that
said means for periodically checking the content of said input directory are adapted to periodically check the content of said input directory automatically.

27. A system as claimed in claim 26,
characterized in that
said system further comprises means for automatically retrieving digital files and/or documents from said input directory.

28. A system as claimed in one of claims 18-26,
characterized in that
said system further comprises means for sending to a remote server (20) data relating to said bitmap stamped and digitally signed and data comprising the hash number of said digital signature.

29. A system as claimed in one of claims 18-28,
characterized in that
said system further comprises means for encrypting said bitmap files stamped and digitally signed.

30. A system as claimed in claim 29,
characterized in that
said encryption means are of the kind SSL.

31. A system as claimed in one of claims 18-30,
characterized in that
said system further comprises means adapted to verify the identity of users wishing to gain access to said system.

32. A system as claimed in claim 31,
characterized in that
said means for verifying the identity of said user comprises means to verify two numbers, the first of which is adapted to enable the second number.
